(19) United States
(12) Patent Application Publication
(10) Pub. No.: US 2015/0233413 A1
(43) Pub. Date: Aug. 20, 2015

(54) LINER FOR A STRING TRIMMER TRANSMISSION ASSEMBLY

(71) Applicant: Actuant Corporation, Menomonee Falls, WI (US)

(72) Inventor: George M. Scherer, Binghamton, NY (US)

(73) Assignee: Actuant Corporation, Menomonee Falls, WI (US)

(21) Appl. No.: 14/428,890

(22) PCT Filed: Sep. 17, 2013
(86) PCT No.: PCT/US13/60104

§ 371 Date: Mar. 17, 2015

Related U.S. Application Data
(60) Provisional application No. 61/701,942, filed on Sep. 17, 2012.

(51) Int. Cl. F16C 1/26; F16C 1/06; A01D 34/416; B29C 47/06; A01D 34/76

(52) U.S. Cl. CPC F16C 1/267; B29C 47/065; A01D 34/76; A01D 34/416; F16C 1/06; B29K 2509/08

(57) ABSTRACT

A transmission assembly (30) for a string trimmer (10) includes a liner (32) having a composite of polymer and glass-filled polymer localized adjacent to the passageway (52) of the liner that receives a power-transmitting flexible shaft (56). The outside surface of the liner is free of glass particles.

### CROSS-REFERENCE TO RELATED APPLICATION

This claims the benefit of U.S. Provisional Patent Application No. 61/701,942 filed Sep. 17, 2012, the disclosure of which is hereby incorporated by reference.

### STATEMENT CONCERNING FEDERALLY SPONSORED RESEARCH OR DEVELOPMENT

Not applicable.

### BACKGROUND OF THE INVENTION

This invention relates to transmission assemblies for string trimmers, and particularly to liners for flexible shafts of such transmission assemblies.

### BACKGROUND OF THE INVENTION

String trimmers (edge trimmers and bladed trimmers) are well-known devices for yard and lawn maintenance that may be used to easily accomplish tasks that may be difficult for other devices, such as trimming plants near a wall using a walk-behind mower. Various types of string trimmers are known in the art; for example, some designs include a battery and an electric motor to provide rotary motion for trimming plants. As another example, other designs include an internal combustion engine to provide rotary motion.

In most cases, the power source connects through an elongated transmission assembly to a rotary whip or blade assembly that trims plants. The power source and the rotary whip assembly are positioned at opposite ends of the transmission assembly to distribute the weight of the trimmer and reduce the amount of torque that must be applied by a user to hold the trimmer. In addition, the transmission assembly may have a curved or bent shape such that the rotary assembly can be positioned away from the user and easily oriented to trim plants.

The transmission assembly of a typical string trimmer includes a hollow outer tube, or a “downtube”, and a flexible plastic liner that generally centers a rotatable drive shaft, or a “core”, within the downtube. A core is typically constructed of multiple helically-wound metal wires to provide flexibility. In some designs, the flexibility of the core permits the core to bend and follow the curve of the downtube and directly connect the power source to the rotary whip assembly. In other curved designs, multiple liners and cores are housed in a single downtube and the cores connect to one another at the bend of the downtube.

Despite their relative simplicity, string trimmer transmission assemblies present design challenges. For example, the rotating motion of the core against the flexible plastic liner generates a significant amount of heat, for example, enough heat to raise the core and liner to an operating temperature of 250 degrees Fahrenheit even if the liner includes a lubricant.

To prevent this heat from damaging the liner, these liners typically were made of a highly heat resistant plastic, such as nylon 6-6, which has relatively high heat and wear resistance properties. Nevertheless, wear can cause some portions of the liner to melt, deteriorate, or simply break off and rub on other portions of the liner as the core rotates. This generates additional heat that can melt portions of the liner and ultimately lead to failure of the transmission assembly.

Moreover, nylon 6-6 is a relatively expensive material that accounts for the majority of the manufacturing costs of the liner, in some cases up to 85% of the liner costs. Similarly, the nylon 6-6 liner and the core are one of the most costly assemblies of an entire string trimmer. Considering the above, core-supporting liners made of other materials have been evaluated as potential replacements for nylon 6-6 liners. However, these materials have failed to perform acceptably in this environment.

Considering the limitations of previous designs, what is needed is an improved string trimmer core-supporting liner that is relatively inexpensive and has relatively high heat and wear resistance properties.

### SUMMARY OF THE INVENTION

In one aspect, the present invention provides a transmission assembly for a string trimmer. The transmission assembly includes a liner that defines a passageway configured to receive a power-transmitting flexible shaft. The liner includes a composite of a low melting point thermoplastic and a high melting point particulate filler localized at the wear surface of the liner, at the surface of the passageway in which the core is received.

Preferably, the particulate filler is adjacent to the inside diameter of the liner, so the core slides against the composite glass filled plastic in operation of the string trimmer.

The outside surface of the liner, including the legs and the outside surface of the sleeve in which the core is received, are preferably free of the filler. Therefore, the filler free thermoplastic is concentrated at the outside of the liner and the filled thermoplastic is concentrated in a layer adjacent the inside of the liner.

Preferably, the particulate filler is glass spheres.

The non-nylon thermoplastic may be a relatively low cost thermoplastic such as polypropylene or polyethylene, for example, or other suitable low melting point thermo-plastic resin.

In another aspect, the present invention provides a transmission assembly for a string trimmer. The transmission assembly includes a liner of the invention. A liner of the invention includes a sleeve having an inner surface that defines a passageway configured to receive a power-transmitting flexible shaft. The glass filler is localized in a thickness of material surrounding the passageway. The sleeve further includes an outer surface opposite the inner surface, and a plurality of legs project from the outer surface of the sleeve and are configured to engage an inner surface of a downtube receiving the liner and the flexible shaft. The thermo-plastic is concentrated at the outer surface of the sleeve and legs, with the outer surface preferably being free of glass filler so as not to wear the production tooling or the downtube, and to facilitate handling.

In yet another aspect, the invention provides a method of manufacturing a liner of the invention for a transmission assembly for a string trimmer. The method includes providing a liner comprising localized glass-filled non-nylon thermoplastic adjacent the passageway that receives the core but not at the outside surface of the liner. In some embodiments, the step of providing the liner includes the steps of: a) delivering the non-nylon thermoplastic to an extruder; b) delivering non-nylon thermoplastic and high temperature particulate filler to a secondary extruder; c) mixing the non-nylon thermoplastic and the filler within the secondary extruder; and d) injecting the filled non-nylon thermoplastic and the non-filled non-nylon thermoplastic into the extrusion head so as to localize the glass filled material adjacent to the passageway and provide the outside surface of the liner substantially free of the glass filler.

The foregoing and other aspects of the invention will appear in the detailed description which follows. In the description, reference is made to the accompanying drawings which illustrate a preferred embodiment of the invention.

### BRIEF DESCRIPTION OF THE DRAWINGS

The invention will hereafter be described with reference to the accompanying drawings, wherein like reference numerals denote like elements, and:

FIG. 1 is a side view of a string trimmer incorporating a liner according to the present invention;

FIG. 2 is a sectional view of a transmission assembly including the liner along line 2-2 of FIG. 1;

FIG. 3 is a side view of the transmission assembly of FIG. 2 with a rotatable core and a downtube partially hidden;

FIG. 4A is a sectional view of the liner along line 2-2 of FIG. 1;

FIG. 4B is a detail view of the liner within the line 4B-4B of FIG. 4A;

FIG. 5 is a flowchart of a method for manufacturing a transmission assembly including a liner according to the present invention;

FIG. 6 is a cross-sectional view through the liner illustrating a layer of glass filled material adjacent to the passageway with stippling and the outside surface of the liner free of glass filler;

FIG. 7 is a schematic view of a production line for a liner of the invention; and

FIG. 8 is a schematic view of an extrusion head for producing a liner of the invention, illustrating flow paths of the filled resin and the filler-free resin.

### DETAILED DESCRIPTION OF THE PREFERRED EMBODIMENT

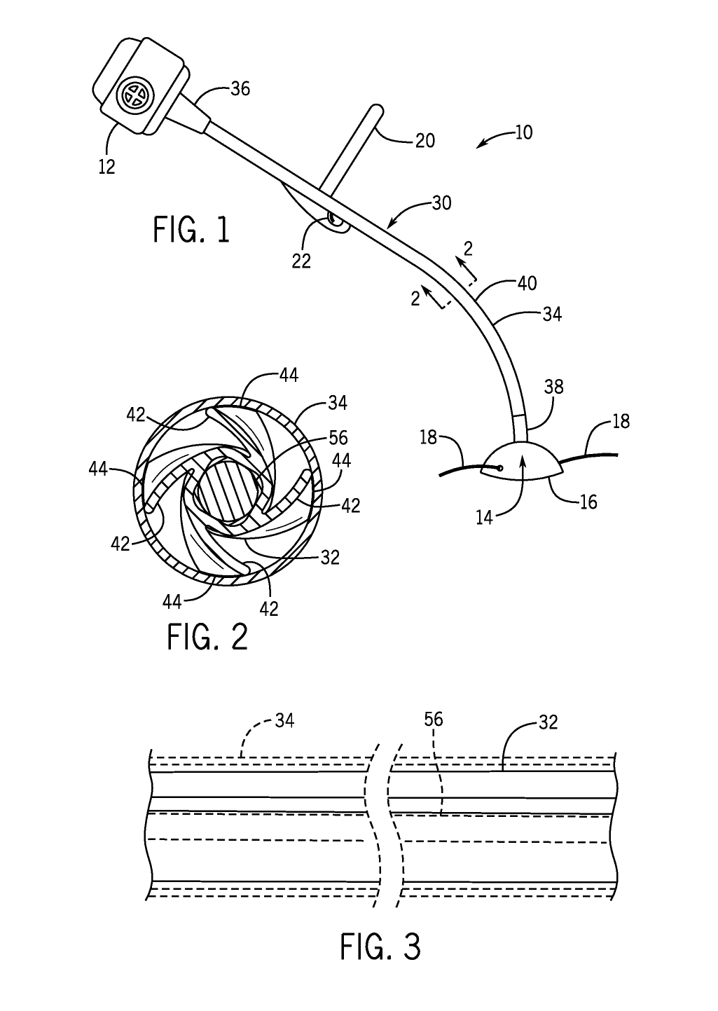

Referring to FIGS. 1-3, a string trimmer 10 includes a transmission assembly 30 having a relatively low cost, flexible, durable, glass-filled nylon liner 32 according to the present invention. The liner 32 has similar, and, in some embodiments, superior, heat and wear resistance properties compared to previous liners that comprised only nylon 6-6. Due to the presence of the glass filler, the liner 32 is also relatively inexpensive compared to previous liners. These aspects and advantages will be described in further detail below.

Generally, the string trimmer 10 also includes a power source 12, such as a battery and electric motor, an internal combustion engine, or the like, that powers a rotary whip assembly 14 that engages and trims plants. The rotary whip assembly 14 includes a rotatable housing 16 that supports one or more plant cutting strings 18, such as plastic cords and other similar cutting elements that are commonly used with string trimmers, or attachments therefor. The string trimmer 10 may also include a support handle 20 and a throttle lever 22 mounted to the transmission assembly 30 that are manipulated by a user. Other components or general string trimmer designs known to those skilled in the art may also or alternatively be used.

The power source 12 powers the rotary whip assembly 14 through the transmission assembly 30, which generally includes a rigid tube that houses flexible inner components. Specifically, the transmission assembly 30 includes a hollow outer tube or a “downtube” 34 formed of a metal, a generally rigid plastic, or the like. The downtube 34 is an elongated hollow component that may include flared ends 36 and 38 to connect to the power source 12 and the rotary whip assembly 14, respectively. In addition, the downtube 34 may have a curve or bend 40 to provide an effective and easily used trimmer design. In an exemplary embodiment, the downtube 34 may have an inner diameter of about 0.9 in.; however, the size and overall length of the downtube 34 may vary depending on the size and power output of the trimmer 10.

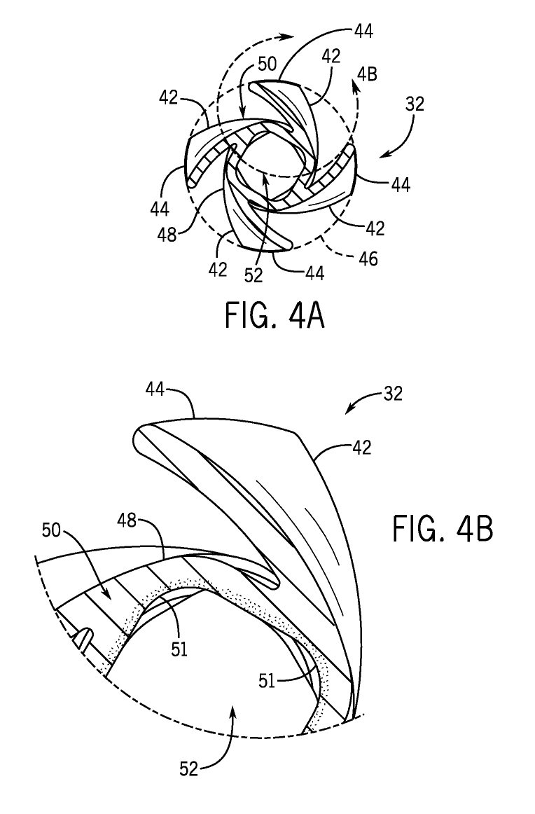

Referring to FIGS. 2-4B, the downtube 34 houses the flexible liner 32 (shown separately in FIGS. 4A and 4B), and the liner 32 may generally extend through the entire or nearly the entire length of the downtube 34. Alternatively, the transmission assembly 30 may include multiple separate flexible liners 32 as described in further detail below.

In any case, the liner 32 includes a plurality of legs 42 that generally center the liner 32 in the downtube 34. Different numbers of legs 42 and leg shapes may be used; in an exemplary embodiment in which the downtube 34 includes a bend, the liner 32 includes four elliptical-shaped and tangentially-projecting legs 42. In alternative embodiments, such as embodiments in which the downtube 34 is straight, the liner 32 may include three elliptical-shaped and tangentially-projecting legs. Furthermore, in some embodiments, each leg may project radially relative to the downtube 34. In the embodiment shown in the Figures, each leg 42 includes a distal end 44 and extends helically along the length of the liner 32. In alternative embodiments, the legs 42 could extend straight along the length of the liner 32. These and other alternative liner shapes are shown and described in further detail in U.S. Pat. No. 5,364,307, U.S. Pat. No. 5,599,233, U.S. Pat. No. 5,695,404, and U.S. Pat. No. 6,913,539, the disclosures of which are hereby incorporated by reference in their entirety. The liner 32 may alternatively have other shapes that are not explicitly described herein without departing from the scope of the invention.

The distal ends 44 of the legs 42 define an effective outer diameter 46 of the liner 32 as shown in FIG. 4A which is equal to or slightly smaller than the inside diameter of the downtube 34. Referring specifically to FIGS. 4A and 4B, each leg 42 includes an end opposite the distal end 44 that integrally connects to an outer surface 48 of a sleeve 50. The sleeve 50 includes an inner passageway 52 opposite the outer surface 48 that may be shaped to have lobes or grooves 51 (FIG. 4B) that retain lubricant therein over the length of the liner 32.

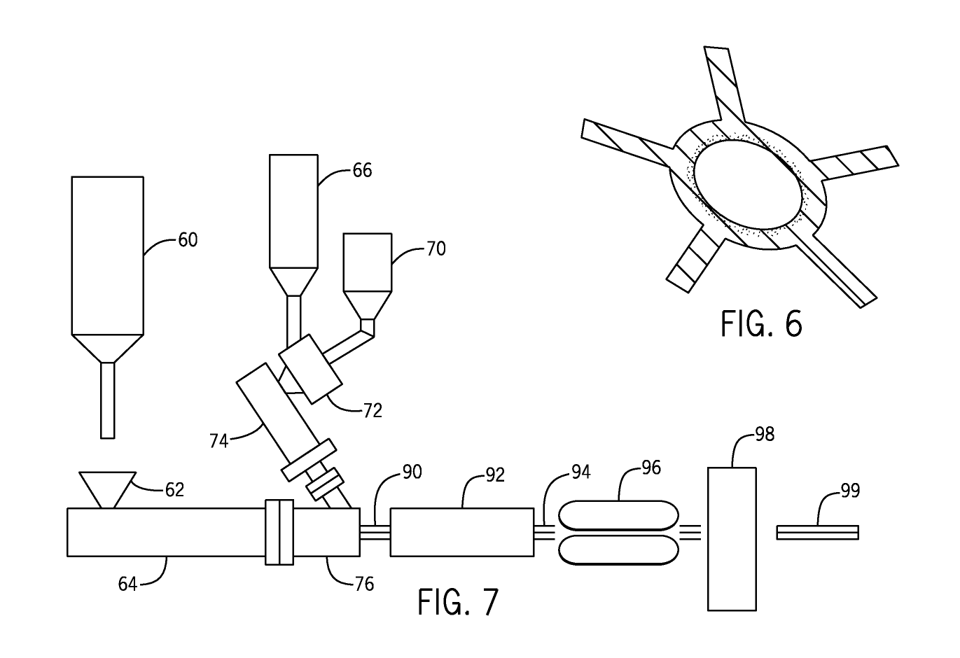

As described briefly above, the liner 32 includes at its inner surface, adjacent the passageway it defines to receive the core, relatively low cost, durable polypropylene or other low melting point thermo-plastic resin with glass filler, preferably 30/40% filler in the filled resin by weight, and localized in the area shown in FIG. 4B or FIG. 6 by stippling, with a thickness of approximately 0.020 inch in the preferred embodiment. Glass filler is less expensive than polypropylene and polypropylene is less expensive than nylon 6-6. As such, a liner 32 having the above percentages of glass filler with a remainder of polypropylene advantageously provides a significant material cost savings over liners that comprise only nylon 6-6.

In addition, the above percentages of glass filler advantageously improve the liner's heat resistance properties by 200 to 300%. As such, the nylon material has been replaced by a less expensive non-nylon thermoplastic/glass composite material having sufficient temperature and wear resistance properties.

In addition to the above advantages, the glass filler is also advantageously inert to lubricants disposed within the sleeve passageway, and moisture. As such, the glass filler does not absorb water after manufacturing the liner 32, which in turn provides greater dimensional stability for the liner 32.

The glass filler is preferably glass spheres or possibly glass shards as opposed to glass fibers, which could render the liner 32 too rigid to follow the bend 40 in the downtube 34. The filler particulate should have a relatively high melting point, i.e., 1000 degrees F. or greater. In addition, the glass filler is most preferably glass spheres because the glass spheres on the inner surface of the sleeve 50 tend to become protrusions. Such protrusions leave a resin matrix having sufficient surface roughness and pockets to retain uniform lubrication within the liner 32 along its length. In contrast, other liner designs may result in the rotatable core, described below, pushing the lubrication to one end of the liner. This structure protects the lines from galling and other modes of failure that prior art liners suffered from, even when made of higher melting point resins. The localization of glass spheres and or glass shards also causes less process tooling wear on the tooling that forms the outer surface of the liner during manufacturing compared to a uniform mix of polypropylene and filler, in which the filler would reside at the outer surface, and also produces a product that is flexible and not brittle as it would be if the glass was uniform throughout the profile. It is possible that a filler other than glass could be used provided it has the requisite thermal wear and chemical resistant properties, and if compatible with the other materials of the liner and trimmer.

Referring specifically now to FIGS. 2 and 3, the inner passageway 52 of the sleeve 50 houses a rotatable flexible shaft or a “core” 56 that rotates inside the liner 32 to provide power from the power source 12 to the rotary whip assembly 14. The core 56 may include square ends that connect to male/female couplings (not shown) that engage the power source 12 and the rotary whip assembly 14. Alternatively, the transmission assembly 30 may include multiple cores 56 connected to one another in embodiments in which the transmission assembly 30 includes multiple liners 32. In any case, the core 56 may be any appropriate core known to those skilled in the art, such as those available from Elliott Manufacturing of Binghamton, N.Y. As such, the core 56 is a flexible component that comprises multiple helically-wound metal wires.

The string trimmer 10 may alternatively or additionally be modified in other forms not explicitly described above. For example, the transmission assembly 30 may include a retainer that inhibits axial motion of the liner 32 within the downtube 34, such as the retainer described and shown in U.S. Pat. App. Pub. 2010/0192386, the disclosure of which is hereby incorporated by reference in its entirety.

### Manufacturing Process

Prior art nylon liners are manufactured by the profile extrusion process. Nylon is procured in the form of pellets from one of several suppliers. The nylon pellets are dried in a hopper which gravity feeds into a single screw extruder. With the addition of external heat, provided by electric heater bands on the extruder and the mechanical action of the screw auger effect, the nylon pellets are melted to a uniform viscous consistency.

A liner of the invention, having a resin/particle composite material adjacent to the passageway and filler-free resin at the outer surface can be produced in a similar process but with modifications, described herein. Referring to FIG. 7, the exterior profile is created by extrusion of just polypropylene or similar low melting point (i.e., low melting point is defined herein as less than 450 degrees F. melting point) thermo-plastic resin contained in a dryer/feeder hopper 60 feeding into a feed throat 62 of a first or primary extruder 64. The filled low melting point thermo-plastic resin is fed from dryer/feeder hopper 66 and may or may not be the same type of resin as the filler-free resin in hopper 60. Preferably, however, the two resins are compatible so that a bond is formed between the filler-free resin and the filled resin at the interface between them in the finished product.

The filler, for example glass powder spheres, are fed in from dryer/feeder hopper 70. The resin from hopper 66 and the filler from hopper 70 are mixed in metered proportion in a proportional mixer/feeder 72, which may be a metering auger pump, and from there are fed into a secondary extruder 74. The secondary extruder 74 makes the resin/filler mixture a composite slurry and injects the composite slurry into the extrusion head 76. The rate of glass injection is controlled to match the rate of polypropylene consumption providing the desired ratio. As the resin is melted, the glass is uniformly mixed in the composite slurry material as both materials migrate through the extrusion process.

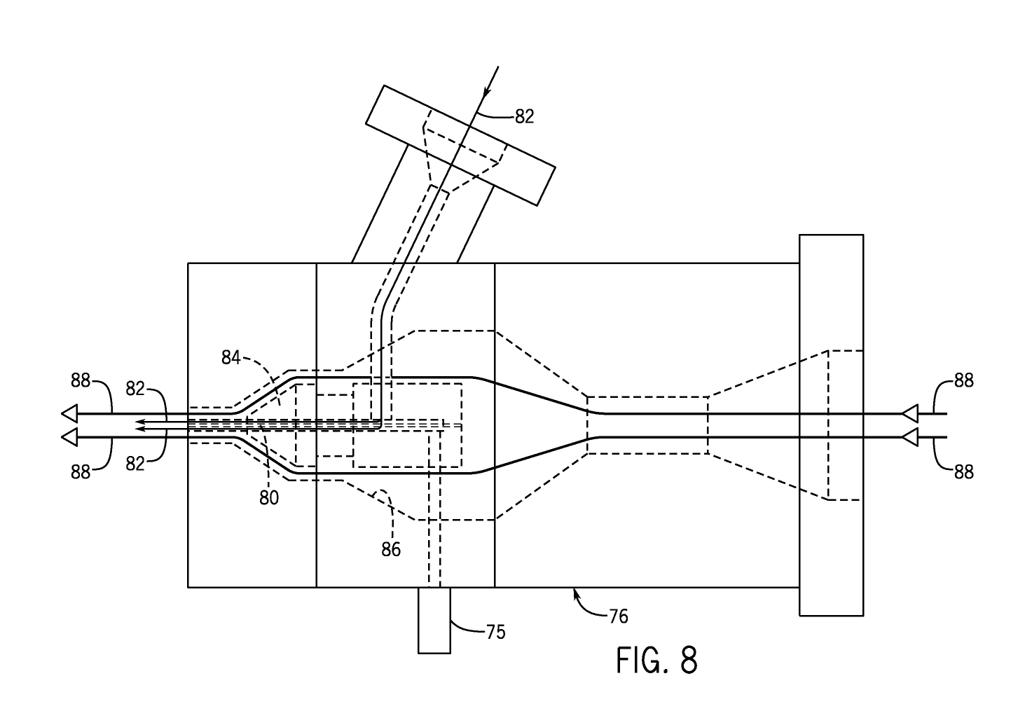

The primary extruder 64 also injects the filler free molten resin into the extrusion head 76, in which the two resin streams are directed to their proper locations as shown in FIG. 8, localizing the composite material next to the pin 80 that forms the passageway that receives the core, in the desired shape and thickness of the composite layer in the final product. As shown in FIG. 8, the composite slurry material 82 from the secondary auger goes into the extruder head from the side to a cavity around pin 80 in a nozzle 84 that is inside the main cavity 86 of the extruder head 76. The nozzle 84 coaxially supports the pin 80 that forms the passageway 52 of the liner, with an annular space between the outlet of the nozzle and the pin. The pin 80 may be supported by any suitable means, typically support legs or a combination of support legs and an end connection. A conventional air vent 75 may also be provided to vent the cavity of the nozzle. The filled resin extrudes out from the nozzle cavity through this annular space around the pin, and the filler-free resin 88 extrudes out around the nozzle and the composite material in the exterior shape of the liner. The two inside flow arrows 82 represent the composite (filled) resin and the two outside flow arrows 88 represent the filler-free resin, at the outlet of the head 76. The amount of pressure exerted by the secondary auger is controlled to yield the desired thickness of the filled resin, for example approximately 0.020 inches in thickness in the preferred embodiment.

As the profile extrusion exits the extruder head 76, it is processed in the same manner as current production of prior art liners. Thus, referring to FIG. 7, the extruded material before sizing is shown at 90, following which it goes into vacuum tank calibration tooling 92, wherefrom it is extruded after sizing at 94 and enters a caterpillar puller 96 that puts the proper amount of tension on the extrusion. Downstream of the puller 96 the extrusion is cut to product size length by in-line cutter 98 to result in finished product 99.

Coloration can be added to the resin glass slurry so that the resultant addition of the composite slurry can be seen and measured in the final profile, assuring the correct thickness and location. In addition, the use of lower melting point resins results in lower energy usage in the manufacturing process and potentially higher production process speeds.

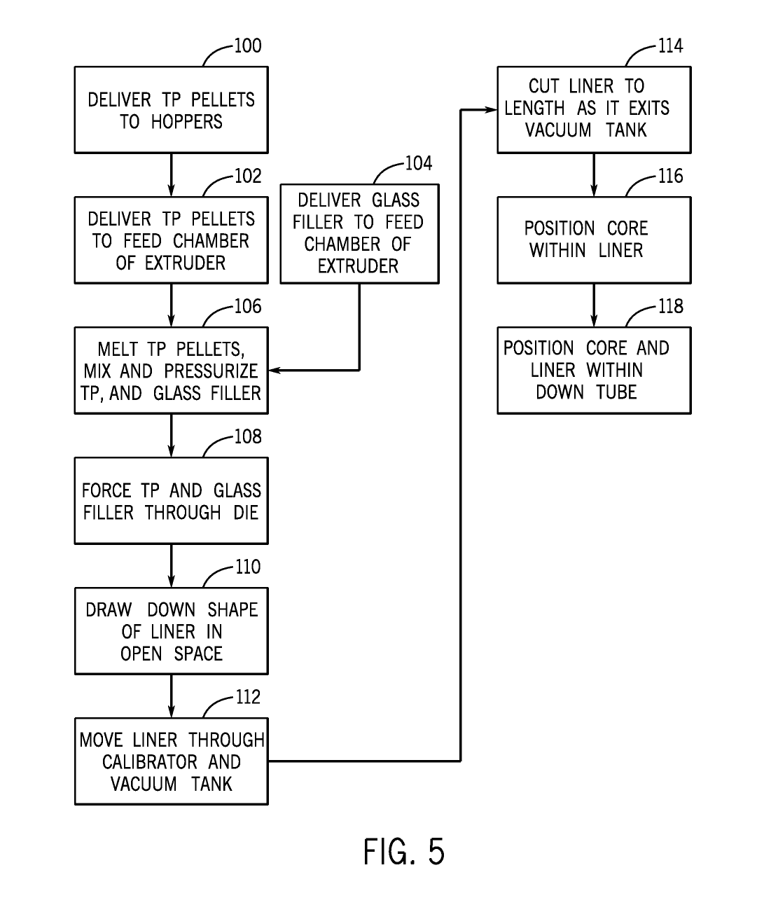

Stepwise, referring to FIG. 5, the transmission assembly 30 is preferably manufactured as follows. First, polypropylene or other low melting point thermo-plastic (TP) pellets are delivered to and dried in hoppers of both the main single-screw extruder and the secondary extruder at step 100. The polypropylene pellets are then delivered to the feed chambers of the primary and secondary extruders at step 102. Simultaneously, glass filler is delivered to the feed chamber of the secondary extruder via a metering auger pump at step 104, that may be mounted on the feed throat of the secondary extruder. The metering auger pump is controlled to deliver an appropriate ratio of glass filler to polypropylene in the filled resin, such as the percentages described above. The polypropylene pellets and glass filler are mixed as they migrate through the extrusion process of the secondary extruder 106. Electric heater bands of the extruder also provide heat to melt the polypropylene pellets as they mix with the glass filler and move through the feed chamber. The mixture of polypropylene and glass filler is also pressurized as it moves through the feed chamber, as is the filler free polypropylene in the primary extruder. The mixture of polypropylene and glass filler is then forced through a port in the extrusion die in the main extruder localizing it on the internal surface of the liner, and the filler-free polypropylene is forced through the extrusion die localizing it adjacent to the exterior surface of the liner. The two materials—the filled resin and the filler free resin—preferably bond to one another between the interior surface and the exterior surface of the liner. The amount of pressure exerted by the secondary extruder controls the thickness of the polypropylene glass mix at step 108.

After exiting the die, the shape of the liner is permitted to draw down in open space at step 110. The liner then enters a calibration chamber or calibrator housed in a vacuum tank at step 112. The calibrator comprises multiple plates that define a cross-sectional shape or “profile” that closely matches the final cross-sectional shape of the liner. The vacuum tank provides a relatively low pressure environment that causes the liner to conform to the shape of the calibrator and cools the liner via constant water flow within the tank. The liner exits the vacuum tank at its final cross-sectional shape and is cut to the desired length at step 114. The rotatable core is positioned within the passageway of the liner at step 116, and the liner and the core are positioned within the downtube at step 118.

The new concept to reduce material cost for the liner while still producing an acceptable component is the addition of a low cost, high temperature, abrasion resistant filler only in the required localized area of a profile constructed from a higher temperature (265 degrees F. plus working temperature) polypropylene material or other lower cost base material such as polyethylene with the appropriate working temperature of 265 degrees F. or more. Spherical glass particles or other high temperature, wear resistant and chemical resistant powdered materials can be the desirable filler for this purpose. Processed glass beads or spheres have the required high temperature properties (well above the required 265 degrees F. working temperature), are abrasion resistant, are inert to moisture and lubricants, and are relatively inexpensive. Glass easily mixes with the base polypropylene material during the extrusion process thus allowing for its insertion during the manufacturing process without the extra cost of external compounding. Glass and other fillers are commonly used with plastic material in the injection molding process to enhance the mechanical properties of the base material. These fillers are in the plastic compound before processing and are then evident within the cross section of the final component.

Beyond the previously mentioned material cost reduction, the addition of the particulate filler provides other benefits. The typical mode of failure for a nylon liner in its typical working application is melting and deterioration of the nylon itself due to galling. The addition of the glass filler improves the thermal properties of the base material resulting in an approx. 200/300% improvement in durability due to thermal degradation caused by galling. The localization of the glass beads only on the internal surface of the liner where the flexible shaft makes contacts provides a surface which is irregular with protrusions caused by the glass spheres. These protrusions provide a surface for the flexible shaft to rub against which is both impervious to degradation due to heat and extremely wear resistant. The combination of the glass filler and localization has allowed for the use of polypropylene as a replacement for nylon. The combination of glass and polypropylene also greatly improves the dimensional stability of the liners since glass is not hydroscopic and polypropylene far less hydroscopic than nylon. The combination will not absorb moisture as readily as nylon, improving dimensional stability post-production.

Localizing the glass only in a thin section on the internal surface of the profile eliminates a breakage problem and allows for glass filler ratios above 25% of filler in the filled resin. As far as tool wear, in previous attempts the glass filler was present on the exterior of the profile which caused premature wear of tooling in the calibrator or sizing section of the tooling. Localizing the glass filler only on the internal surface eliminates this problem.

From the above description, it should be apparent that the liner according to the present invention has similar, and, in some embodiments, superior, heat and wear resistance properties compared to previous liners that comprised only nylon 6-6. In addition, the liner according to the present invention is also relatively inexpensive in material and processing costs compared to previous liners.

A preferred embodiment of the invention has been described in considerable detail. Many modifications and variations to the preferred embodiment described will be apparent to a person of ordinary skill in the art. Therefore, the invention should not be limited to the embodiment described, but should be defined by the claims that follow.

I claim:

1. A transmission assembly for a string trimmer, comprising:
a liner defining a passageway configured to receive a power-transmitting flexible shaft, the liner including a composite of plastic and localized particulate filler adjacent to the passageway, the liner having an outer surface that is substantially free of the particulate filler.

2. The transmission assembly of claim 1, wherein the plastic is a non-nylon thermo-plastic.

3. The transmission assembly of claim 1, wherein the particulate filler is glass particles.

4. The transmission assembly of claim 3, wherein the glass particles are substantially spherical.

5. The transmission assembly of claim 1, wherein the composite comprises at least 25% of the filler by weight of the filled layer adjacent to the passageway.

6. The transmission assembly of claim 1, wherein the liner includes a sleeve having an inner surface that defines the passageway configured to receive the power-transmitting flexible shaft.

7. The transmission assembly of claim 6, wherein the liner includes a plurality of legs extending radially away from an outer surface of the sleeve, the plurality of legs being configured to engage an inner surface of a downtube receiving the liner and the flexible shaft.

8. A string trimmer comprising the transmission assembly of claim 7, and the string trimmer further comprising: a power-transmitting flexible shaft received in the passageway of the liner; a downtube receiving the liner and the flexible shaft; a power source connected to a first end of the power-transmitting flexible shaft and configured to rotate the flexible shaft; and a rotary whip assembly connected to a second end of the rotatable flexible shaft and thereby configured to be rotated by the power source via the flexible shaft.

9. The transmission assembly of claim 1, further comprising the power-transmitting flexible shaft received in the passageway of the liner.

10. The transmission assembly of claim 1, further comprising a downtube receiving the liner.

11. A transmission assembly for a string trimmer, comprising: a liner including a sleeve having an inner surface defining a passageway configured to receive a power-transmitting flexible shaft, and the sleeve further including an outer surface opposite the inner surface; and a plurality of legs projecting from the outer surface of the sleeve and configured to engage an inner surface of a downtube receiving the liner and the flexible shaft, the liner being made of thermo-plastic and having particulate filler in the thermo-plastic adjacent to the passageway and thermo-plastic that is substantially free of particulate filler in the legs and outer surface of the sleeve.

12. The transmission assembly of claim 11, wherein the thermo-plastic is a non-nylon thermo-plastic.

13. The transmission assembly of claim 12, wherein the particulate filler is glass.

14. The transmission assembly of claim 13, wherein the particulate glass filler is spherical glass beads.

15. A method of manufacturing a liner for a transmission assembly for a string trimmer, the liner having an exterior surface and an interior passageway in which a power transmitting rotary shaft is received, comprising the steps of:
extruding a composite flow of a thermo-plastic resin of a low melting point containing a particulate filler of a high melting point into an extruder head;
extruding a primary flow of a thermo-plastic resin of a low melting point that is free of the particulate filler into the extruder head;
directing the composite flow inside the extruder head to position the composite flow adjacent to the passageway;
directing the primary flow inside the extruder head to position the primary flow adjacent to the exterior surface of the liner; and
extruding the composite flow and the primary flow from the extruder head, with the composite flow adjacent to the passageway, the primary flow adjacent to the exterior surface of the liner, and the two flows bonded to one another between the passageway and the exterior surface of the liner.

16. The method of claim 15, wherein the resins of the composite flow and the primary flow are of the same type of resin.

17. The method of claim 15, wherein the resins of the composite flow and the primary flow are of different types of resin.

18. The method of claim 15, wherein the resin of the composite flow and the primary flow is polypropylene.

19. The method of claim 15, wherein the filler is glass particles.

20. The method of claim 19, wherein the glass particles are spherical.
